(19) United States
(12) Patent Application Publication
(10) Pub. No.: US 2014/0321749 A1
(43) Pub. Date: Oct. 30, 2014

(54) SYSTEM AND HANDWRITING SEARCH METHOD

(71) Applicant: KABUSHIKI KAISHA TOSHIBA, Tokyo (JP)

(72) Inventor: Hideki Tsutsui, Kawasaki-shi (JP)

(73) Assignee: KABUSHIKI KAISHA TOSHIBA, Tokyo (JP)

(21) Appl. No.: 14/142,574

(22) Filed: Dec. 27, 2013

Related U.S. Application Data
(63) Continuation of application No. PCT/JP2013/062384, filed on Apr. 26, 2013.

(51) Int. Cl. G06K 9/00

(52) U.S. Cl. CPC G06K 9/00463
USPC 382/186

(57) ABSTRACT

According to one embodiment, a system includes an input and a processor. The input inputs first strokes which indicate a search key. The processor executes a handwriting search to search for second strokes corresponding to the first strokes from a handwritten document. The processor determines whether the second strokes searched by the handwriting search should be regarded as a search result corresponding to the search key, in accordance with an outer shape of the first strokes and an outer shape of the second strokes.

### CROSS REFERENCE TO RELATED APPLICATIONS

This application is a Continuation Application of PCT Application No. PCT/JP2013/062384, filed Apr. 26, 2013, the entire contents of which are incorporated herein by reference.

### FIELD

Embodiments described herein relate generally to a technique of processing a handwritten document.

### BACKGROUND

In recent years, various kinds of electronic devices, such as a tablet, a PDA and a smartphone, have been developed. Most of these electronic devices include touch-screen displays for facilitating input operations by users.

By touching a menu or an object, which is displayed on the touch-screen display, by a finger or the like, the user can instruct an electronic device to execute a function which is associated with the menu or object.

However, most of existing electronic devices with touch-screen displays are consumer products which are designed to enhance operability on various media data such as video and music, and are not necessarily suitable for use in a business situation such as a meeting, a business negotiation or product development. Thus, in business situations, paper-based pocket notebooks have still been widely used.

Recently, an online handwritten character recognition technique for recognizing handwritten characters has also been developed.

Conventionally, however, no consideration has been given to a technique for efficiently searching for a desired handwritten document.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external appearance of an electronic device which is used in a system according to an embodiment.

FIG. 2 is an exemplary view illustrating a cooperative operation between the electronic device of FIG. 1 and an external apparatus.

FIG. 3 is a view illustrating an example of a handwritten document which is handwritten on a touch-screen display of the electronic device of FIG. 1.

FIG. 4 is an exemplary view for explaining time-series information corresponding to the handwritten document of FIG. 3, the time-series information being generated by the electronic device of FIG. 1.

FIG. 5 is an exemplary block diagram illustrating a system configuration of the electronic device of FIG. 1.

FIG. 6 is an exemplary block diagram illustrating a functional configuration of a digital notebook application program which is executed by the electronic device of FIG. 1.

FIG. 7 is an exemplary view for explaining strokes which may possibly be erroneously searched in a handwriting search that is executed by the electronic device of FIG. 1, and a process for excluding these strokes from a search result.

FIG. 8 is an exemplary view for explaining strokes which may possibly be erroneously searched in a handwriting search that is executed by the electronic device of FIG. 1, and another process for excluding these strokes from a search result.

FIG. 9 is an exemplary flowchart illustrating the procedure of a handwriting search process which is executed by the electronic device of FIG. 1.

FIG. 10 is an exemplary flowchart illustrating a handwriting search screen which is displayed by the electronic device of FIG. 1.

FIG. 11 is an exemplary view illustrating a search result which is displayed on the handwriting search screen of FIG. 10.

FIG. 12 is an exemplary view illustrating a state of a jump from the handwriting search screen of FIG. 10 to a certain handwritten page.

### DETAILED DESCRIPTION

Various embodiments will be described hereinafter with reference to the accompanying drawings.

In general, according to one embodiment, a system includes an input and a processor. The input is configured to input first strokes which indicate a search key. The processor is configured to execute a handwriting search to search for second strokes corresponding to the first strokes from a handwritten document. The processor determines whether the second strokes searched by the handwriting search should be regarded as a search result corresponding to the search key, based on an outer shape of the first strokes and an outer shape of the second strokes.

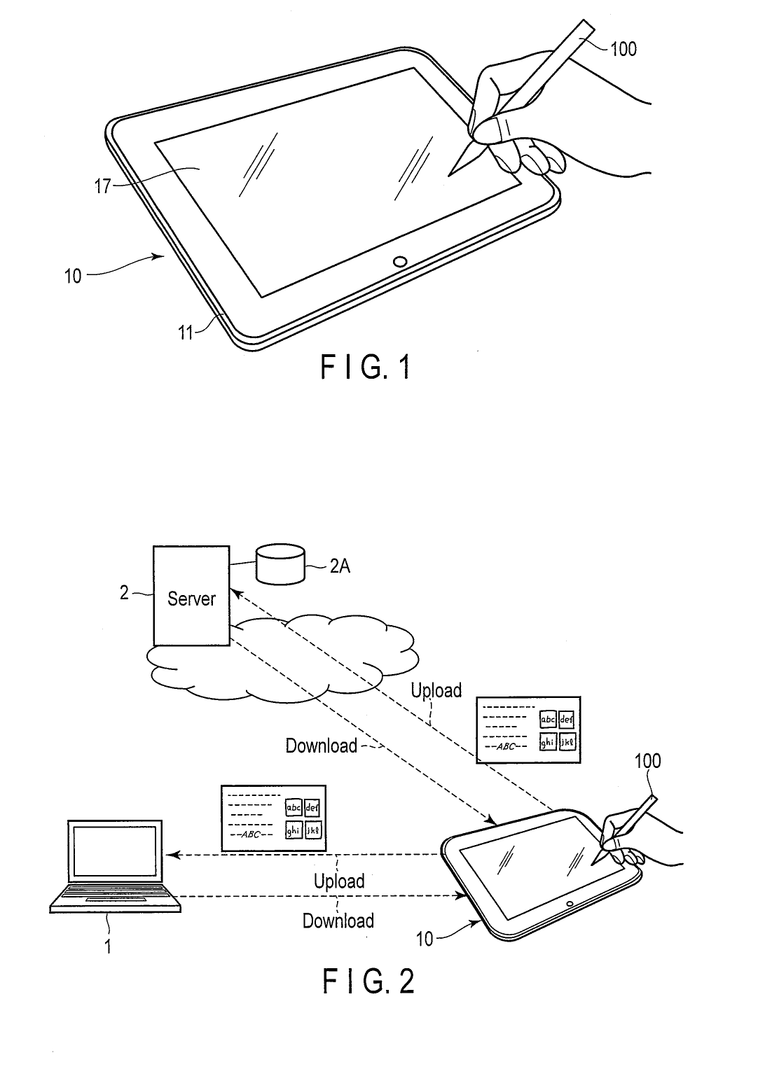

FIG. 1 is a perspective view illustrating an external appearance of an electronic device which is used in a system according to an embodiment. The electronic device is, for instance, a pen-based portable electronic device which can execute a handwriting input by a pen or a finger. This electronic device may be realized as a tablet computer, a notebook-type personal computer, a smartphone, a PDA, etc. In the description below, the case is assumed that this electronic device is realized as a tablet computer 10. The tablet computer 10 is a portable electronic device which is also called “tablet” or “slate computer”. As shown in FIG. 1, the tablet computer 10 includes a main body 11 and a touch-screen display 17. The main body 11 has a thin box-shaped housing. The touch-screen display 17 is attached such that the touch-screen display 17 is laid over the top surface of the main body 11.

In the touch-screen display 17, a flat-panel display and a sensor, which is configured to detect a touch position of a pen or a finger on the screen of the flat-panel display, are assembled. The flat-panel display may be, for instance, a liquid crystal display (LCD). As the sensor, for example, use may be made of an electrostatic capacitance-type touch panel, or an electromagnetic induction-type digitizer. In the description below, the case is assumed that two kinds of sensors, namely a digitizer and a touch panel, are both assembled in the touch-screen display 17.

The digitizer is disposed, for example, under the screen of the flat-panel display. The touch panel is disposed, for example, over the screen of the flat-panel display. The touch-screen display 17 can detect not only a touch operation on the screen with use of a finger, but also a touch operation on the screen with use of a pen 100. The pen 100 may be, for instance, an electromagnetic-induction pen. The user can execute a handwriting input operation on the touch-screen display 17 by using an external object (pen 100 or finger). During the handwriting input operation, a locus of movement of the external object (pen 100 or finger) on the screen, that is, a locus (trace of writing) of a stroke which is handwritten by a handwriting input operation, is drawn in real time, and thereby the loci of respective strokes are displayed on the screen. A locus of movement of the external object during a time in which the external object is in contact with the screen corresponds to one stroke. A set of many strokes corresponding to handwritten characters or graphics, that is, a set of many loci (traces of writing), constitutes a handwritten document.

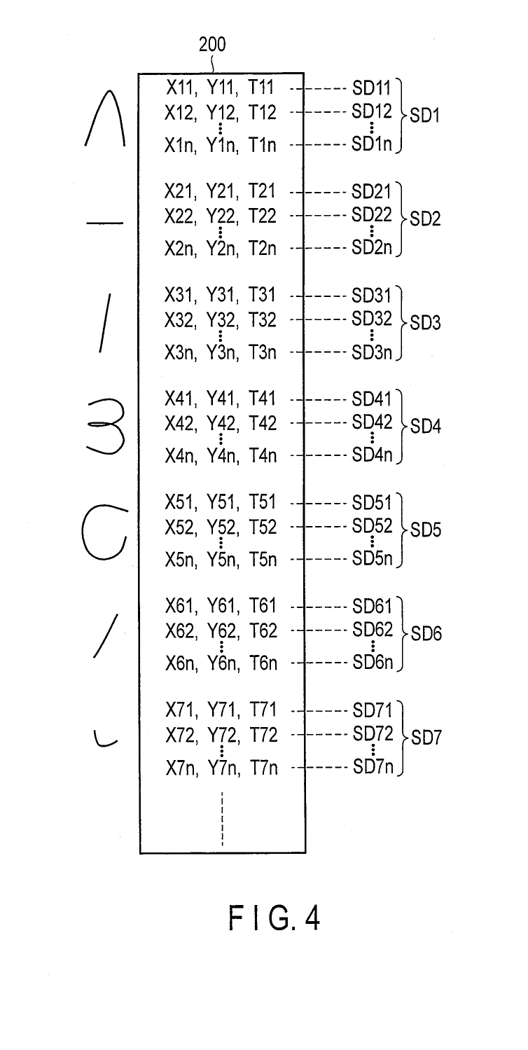

In the present embodiment, this handwritten document is stored in a storage medium not as image data but as time-series information indicative of coordinate series of the loci of strokes and the order relation between the strokes. The details of this time-series information will be described later with reference to FIG. 4. This time-series information indicates an order in which a plurality of strokes are handwritten, and includes a plurality of stroke data corresponding to a plurality of strokes. In other words, the time-series information means a set of time-series stroke data corresponding to a plurality of strokes. Each stroke data corresponds to one stroke, and includes coordinate data series (time-series coordinates) corresponding to points on the locus of this stroke. The order of arrangement of these stroke data corresponds to an order in which strokes are handwritten, that is, an order of strokes.

The tablet computer 10 can read out arbitrary existing time-series information (handwritten document) from the storage medium, and can display on the screen a handwritten document corresponding to this time-series information, that is, the loci corresponding to a plurality of strokes indicated by this time-series information. Furthermore, the tablet computer 10 has an edit function. The edit function can delete or move an arbitrary stroke or an arbitrary handwritten character or the like in the displayed handwritten document, in accordance with an edit operation by the user with use of an “eraser” tool, a range designation tool, and other various tools. Besides, this edit function includes an operation of clearing the history of some handwriting operations.

In addition, the tablet computer 10 includes a handwriting search (stroke search) function. The handwriting search may be of any kind, if it is possible that with use of at least one stroke (query stroke) which is handwritten as a search key (query), at least one stroke corresponding to this query stroke can be searched from an arbitrary handwritten document. In this handwriting search, it is also possible to search for a handwritten document, which includes at least one stroke corresponding to at least one query stroke, from a storage medium. The at least one stroke corresponding to at least one query stroke may be, for example, at least one stroke which is similar to at least one query stroke. In the handwriting search, for example, at least one stroke having a characteristic amount similar to a characteristic amount of a query stroke is searched from a handwritten document by matching (stroke matching) between the query stroke and each of a plurality of strokes in the handwritten document. When a plurality of strokes are input by handwriting as a search key (query), the above-described stroke matching is executed with respect to each of the query strokes.

As the characteristic amount of a certain stroke, use can be made of an arbitrary feature which can represent a handwriting feature of this stroke. For example, as the characteristic amount, use may be made of a shape of a stroke, a direction of writing of a stroke, an inclination of a stroke, etc.

The handwriting search enables the user to easily find a desired handwritten document from many handwritten documents which were created in the past, or to easily find a desired handwritten portion from a certain handwritten document. The handwriting search can search for not only a handwritten character, but also a handwritten graphic, a handwritten mark, etc.

In this embodiment, the above-described time-series information (handwritten document) may be managed as one page or plural pages. In this case, the time-series information (handwritten document) may be divided in units of an area which falls within one screen, and thereby a piece of time-series information, which falls within one screen, may be stored as one page. Alternatively, the size of one page may be made variable. In this case, since the size of a page can be increased to an area which is larger than the size of one screen, a handwritten document of an area larger than the size of the screen can be handled as one page. When one whole page cannot be displayed on the display at a time, this page may be reduced in size and displayed, or a display target part in the page may be moved by vertical and horizontal scroll.

FIG. 2 shows an example of a cooperative operation between the tablet computer 10 and an external apparatus. The tablet computer 10 can cooperate with a personal computer 1 or a cloud. Specifically, the tablet computer 10 includes a wireless communication device of, e.g. wireless LAN, and can wirelessly communicate with the personal computer 1. Further, the tablet computer 10 can communicate with a server 2 on the Internet. The server 2 may be a server which executes an online storage service, and other various cloud computing services.

The personal computer 1 includes a storage device such as a hard disk drive (HDD). The tablet computer 10 can transmit time-series information (handwritten document) to the personal computer 1 over a network, and can store the time-series information (handwritten document) in the HDD of the personal computer 1 (“upload”). In order to ensure a secure communication between the tablet computer 10 and personal computer 1, the personal computer 1 may authenticate the tablet computer 10 at a time of starting the communication. In this case, a dialog for prompting the user to input an ID or a password may be displayed on the screen of the tablet computer 10, or the ID of the tablet computer 10, for example, may be automatically transmitted from the tablet computer 10 to the personal computer 1.

Thereby, even when the capacity of the storage in the tablet computer 10 is small, the tablet computer 10 can handle many pieces of time-series information (handwritten documents) or large-volume time-series information (handwritten document).

In addition, the tablet computer 10 can read out (“download”) at least one arbitrary handwritten document stored in the HDD of the personal computer 1, and can display the loci of strokes indicated by the read-out handwritten document on the screen of the display 17 of the tablet computer 10. In this case, the tablet computer 10 may display on the screen of the display 17 a list of thumbnails which are obtained by reducing in size pages of plural handwritten documents, or may display one page, which is selected from these thumbnails, on the screen of the display 17 in the normal size.

Furthermore, the destination of communication of the tablet computer 10 may be not the personal computer 1, but the server 2 on the cloud which provides storage services, etc., as described above. The tablet computer 10 can transmit a handwritten document to the server 2 over the network, and can store the handwritten document in a storage device 2A of the server 2 (“upload”). Besides, the tablet computer 10 can read out an arbitrary handwritten document which is stored in the storage device 2A of the server 2 (“download”) and can display the loci of strokes indicated by the handwritten document on the screen of the display 17 of the tablet computer 10.

As has been described above, in the present embodiment, the storage medium in which handwritten documents are stored may be the storage device in the tablet computer 10, the storage device in the personal computer 1, or the storage device in the server 2.

In addition, the system of the embodiment, which can execute the above-described handwriting search, may be either a local system which is realized in the tablet computer 10, or a system (server system) which is composed of one or more servers. In this case, the tablet computer 10 may function as a client terminal which can execute a process of transmitting query strokes to the server system, and a process of receiving a search result from the server system and displaying the search result on the screen of the tablet computer 10.

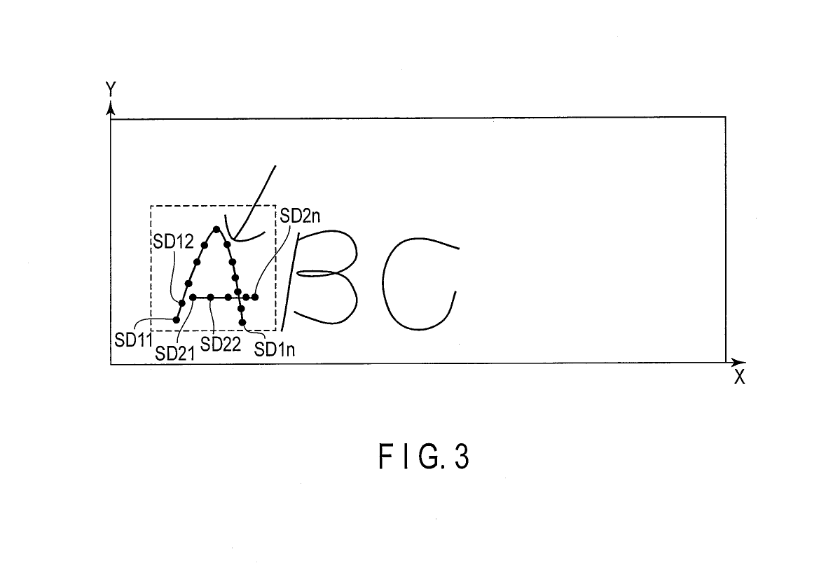

Next, referring to FIG. 3 and FIG. 4, a description is given of a relationship between strokes (characters, marks, graphics, tables, etc.), which are handwritten by the user, and a handwritten document. FIG. 3 shows an example of a handwritten character string which is handwritten on the touch-screen display 17 by using the pen 100 or the like.

In many cases, on a handwritten document, other characters or graphics are handwritten over already handwritten characters or graphics. In FIG. 3, the case is assumed that a handwritten character string “ABC” was handwritten in the order of “A”, “B” and “C”, and thereafter a handwritten arrow was handwritten near the handwritten character “A”.

The handwritten character “A” is expressed by two strokes (a locus of “ [symbol] ” shape, a locus of “-” shape) which are handwritten by using the pen 100 or the like, that is, by two loci. The locus of the pen 100 of the first handwritten “ [symbol] ” shape is sampled in real time, for example, at regular time intervals, and thereby time-series coordinates SD11, SD12, . . . , SD1n of the stroke of the “ [symbol] ” shape are obtained. Similarly, the locus of the pen 100 of the next handwritten “-” shape is sampled in real time, for example, at regular time intervals, and thereby time-series coordinates SD21, SD22, . . . , SD2n of the stroke of the “-” shape are obtained.

The handwritten character “B” is expressed by two strokes which are handwritten by using the pen 100 or the like, that is, by two loci. The handwritten character “C” is expressed by one stroke which is handwritten by using the pen 100 or the like, that is, by one locus. The handwritten “arrow” is expressed by two strokes which are handwritten by using the pen 100 or the like, that is, by two loci.

FIG. 4 illustrates time-series information 200 corresponding to the handwritten character string of FIG. 3. The time-series information 200 includes a plurality of stroke data SD1, SD2, . . . , SD7. In the time-series information 200, the stroke data SD1, SD2, . . . , SD7 are arranged in time series in the order of strokes, that is, in the order in which plural strokes are handwritten.

In the time-series information 200, the first two stroke data SD1 and SD2 are indicative of two strokes of the handwritten character “A”. The third and fourth stroke data SD3 and SD4 are indicative of two strokes which constitute the handwritten character “B”. The fifth stroke data SD5 is indicative of one stroke which constitutes the handwritten character “C”. The sixth and seventh stroke data SD6 and SD7 are indicative of two strokes which constitute the handwritten “arrow”.

Each stroke data includes coordinate data series (time-series coordinates) corresponding to one stroke, that is, a plurality of coordinates corresponding to a plurality of points on the locus of one stroke. In each stroke data, the plural coordinates are arranged in time series in the order in which the stroke is written. For example, as regards handwritten character “A”, the stroke data SD1 includes coordinate data series (time-series coordinates) corresponding to the points on the locus of the stroke of the “ [symbol] ” shape of the handwritten character “A”, that is, an n-number of coordinate data SD11, SD12, . . . , SD1n. The stroke data SD2 includes coordinate data series corresponding to the points on the locus of the stroke of the “-” shape of the handwritten character “A”, that is, an n-number of coordinate data SD21, SD22, . . . , SD2n. Incidentally, the number of coordinate data may differ between respective stroke data. Specifically, since the locus of the pen 100 is sampled in real time at regular time intervals, the number of coordinate data becomes larger as the length of the stroke is greater or as the speed of handwriting of the stroke is lower.

Each coordinate data is indicative of an X coordinate and a Y coordinate, which correspond to one point in the associated locus. For example, the coordinate data SD11 is indicative of an X coordinate (X11) and a Y coordinate (Y11) of the starting point of the stroke of the “ [symbol] ” shape. The coordinate data SD1n is indicative of an X coordinate (X1n) and a Y coordinate (Y1n) of the end point of the stroke of the “ [symbol] ” shape.

Further, each coordinate data may include time stamp information T corresponding to a time point at which a point corresponding to this coordinate data was handwritten. The time point at which the point was handwritten may be either an absolute time (e.g. year/month/day/hour/minute/second) or a relative time with reference to a certain time point. For example, an absolute time (e.g. year/month/day/hour/minute/second) at which a stroke began to be handwritten may be added as time stamp information to each stroke data, and furthermore a relative time indicative of a difference from the absolute time may be added as time stamp information T to each coordinate data in the stroke data.

In this manner, by using the time-series information in which the time stamp information T is added to each coordinate data, the temporal relationship between strokes can be more precisely expressed.

Moreover, information (Z) indicative of a pen stroke pressure may be added to each coordinate data.

The time-series information (handwritten document information) 200 having the structure as described with reference to FIG. 4 can express not only the trace of handwriting of each stroke, but also the temporal relation between strokes. Thus, with the use of the time-series information 200, even if a distal end portion of the handwritten “arrow” is written over the handwritten character “A” or near the handwritten character “A”, as shown in FIG. 3, the handwritten character “A” and the distal end portion of the handwritten “arrow” can be treated as different characters or graphics. In the meantime, the time stamp information T may be used as option information, and a plurality of stroke data each including no time stamp information T may be used as the above-described time-series information.

Furthermore, in the present embodiment, as described above, a handwritten document is stored not as an image or a result of character recognition, but as a set of time-series stroke data. Thus, handwritten characters can be handled, without depending on languages of the handwritten characters. Therefore, the structure of the handwritten document (time-series information) 200 of the embodiment can be commonly used in various countries of the world where different languages are used.

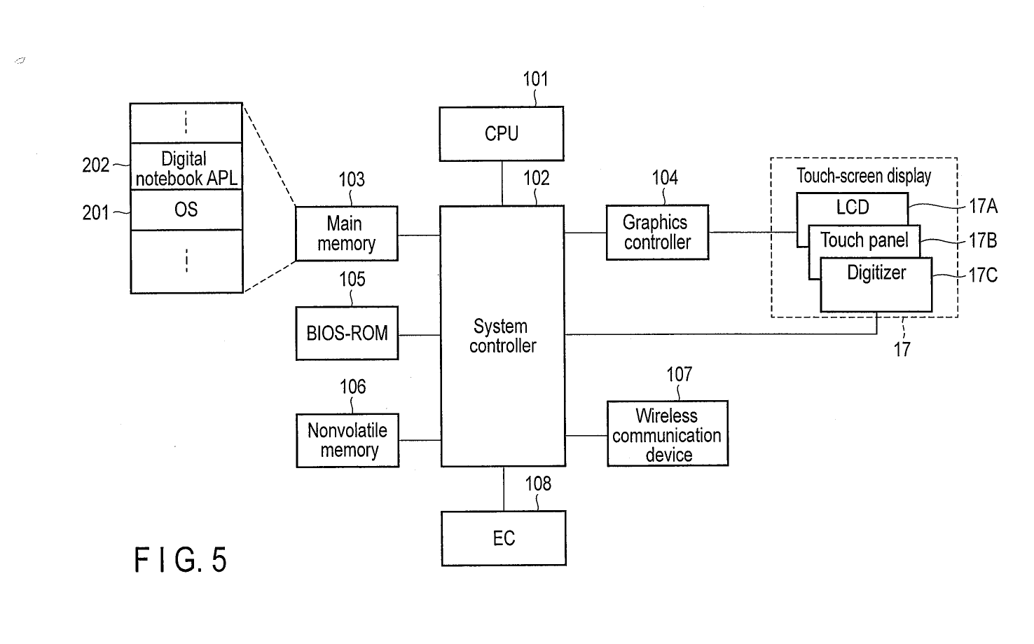

FIG. 5 shows a system configuration of the tablet computer 10.

As shown in FIG. 5, the tablet computer 10 includes a CPU 101, a system controller 102, a main memory 103, a graphics controller 105, a BIOS-ROM 105, a nonvolatile memory 106, a wireless communication device 107, and an embedded controller (EC) 108.

The CPU 101 is a processor which controls the operations of various modules in the tablet computer 10. The CPU 101 executes various kinds of software, which are loaded from the nonvolatile memory 106 that is a storage device into the main memory 103. The software includes an operating system (OS) 201 and various application programs. The application programs include a digital notebook application program 202. The digital notebook application program 202 includes a function of creating and displaying the above-described handwritten document, a function of editing the handwritten document, a handwriting search function, and a recognition function.

In addition, the CPU 101 executes a basic input/output system (BIOS) which is stored in the BIOS-ROM 105. The BIOS is a program for hardware control.

The system controller 102 is a device which connects a local bus of the CPU 101 and various components. The system controller 102 includes a memory controller which access-controls the main memory 103. In addition, the system controller 102 includes a function of communicating with the graphics controller 104 via, e.g. a PCI EXPRESS serial bus.

The graphics controller 104 is a display controller which controls an LCD 17A that is used as a display monitor of the tablet computer 10. A display signal, which is generated by the graphics controller 104, is sent to the LCD 17A. The LCD 17A displays a screen image based on the display signal. A touch panel 17B and a digitizer 17C are disposed on the LCD 17A. The touch panel 17B is an electrostatic capacitance-type pointing device for executing an input on the screen of the LCD 17A. A contact position on the screen, which is touched by a finger, and a movement of the contact position are detected by the touch panel 17B. The digitizer 17C is an electromagnetic induction-type pointing device for executing an input on the screen of the LCD 17A. A contact position on the screen, which is touched by the pen 100, and a movement of the contact position are detected by the digitizer 17C.

The wireless communication device 107 is a device configured to execute wireless communication such as wireless LAN or 3G mobile communication. The EC 108 is a one-chip microcomputer including an embedded controller for power management. The EC 108 includes a function of powering on or powering off the tablet computer 10 in accordance with an operation of a power button by the user.

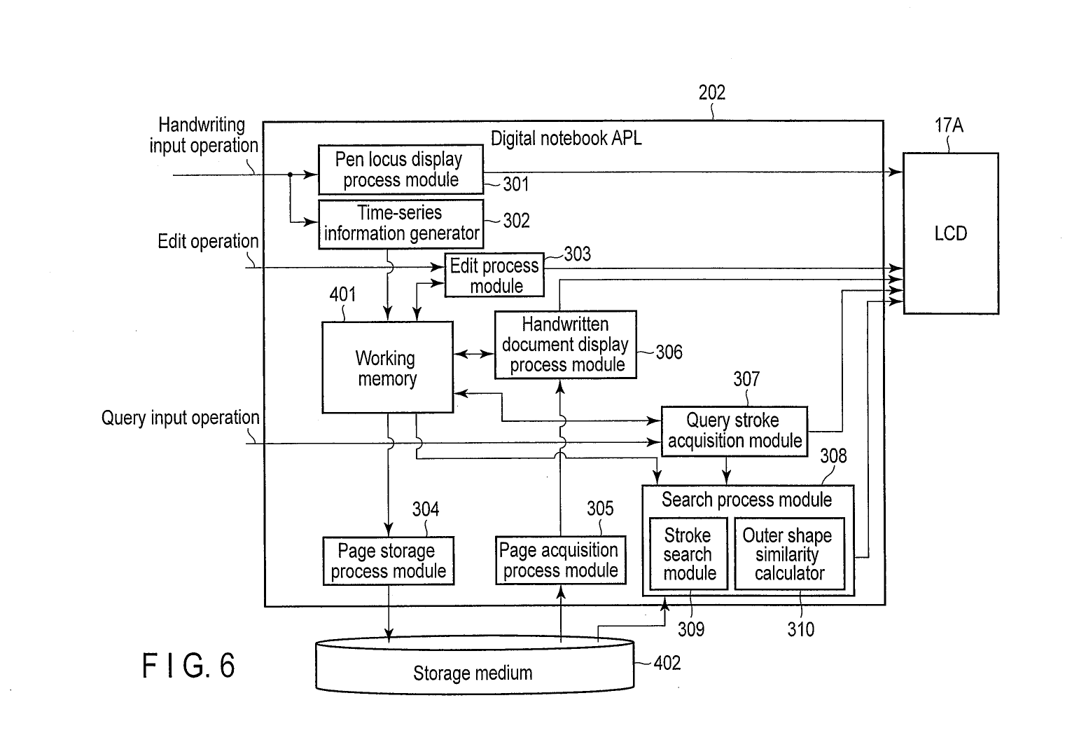

Next, referring to FIG. 6, a description is given of a functional configuration of the digital notebook application program 202.

The digital notebook application program 202 includes a pen locus display process module 301, a time-series information generator 302, an edit process module 303, a page storage process module 304, a page acquisition process module 305, a handwritten document display process module 306, a query stroke acquisition module 307, and a search process module 308.

The digital notebook application program 202 executes creation, display and edit of a handwritten document (handwritten data) by using stroke data which is input by using the touch-screen display 17. The touch-screen display 17 is configured to detect the occurrence of events such as “touch”, “move (slide)” and “release”. The “touch” is an event indicating that an external object has come in contact with the screen. The “move (slide)” is an event indicating that the position of contact of the external object has been moved while the external object is in contact with the screen. The “release” is an event indicating that the external object has been released from the screen.

The pen locus display process module 301 and time-series information generator 302 receive an event of “touch” or “move (slide)” which is generated by the touch-screen display 17, thereby detecting a handwriting input operation. The “touch” event includes coordinates of a contact position. The “move (slide)” event also includes coordinates of a contact position at a destination of movement. Thus, the pen locus display process module 301 and time-series information generator 302 can receive coordinate series, which correspond to the locus of movement of the contact position, from the touch-screen display 17.

The pen locus display process module 301 receives coordinate series from the touch-screen display 17 and displays, based on the coordinate series, the loci of plural strokes, which are input by a handwriting input operation with use of the pen 100 or the like, on the screen of the LCD 17A in the touch-screen display 17. By the pen locus display process module 301, the locus of the pen 100 during a time in which the pen 100 is in contact with the screen, that is, the locus of each stroke, is drawn on the screen of the LCD 17A.

The time-series information generator 302 receives the above-described coordinate series which are output from the touch-screen display 17, and generates, based on the coordinate series, a plurality of stroke data (time-series information) corresponding to the above-described plural strokes. The stroke data (time-series information), that is, the coordinates corresponding to the respective points of each stroke and the time stamp information of each stroke, may be temporarily stored in a working memory 401.

The page storage process module 304 stores plural stroke data corresponding to plural strokes in a storage medium 402. The storage medium 402, as described above, may be the storage device in the tablet computer 10, the storage device in the personal computer 1, or the storage device in the server 2.

The page acquisition process module 305 reads out from the storage medium 402 an arbitrary handwritten document which is already stored in the storage medium 402. The read-out handwritten document is sent to the handwritten document display process module 306. The handwritten document display process module 306 analyzes the handwritten document and displays, based on the analysis result, the loci of plural strokes indicated by plural stroke data in the handwritten document on the screen as a handwritten page.

The edit process module 303 executes a process for editing a handwritten document (handwritten page) which is currently being displayed. Specifically, in accordance with an edit operation which is executed by the user on the touch-screen display 17, the edit process module 303 executes an edit process for deleting or moving one or more strokes of a plurality of stokes which are being displayed. Further, the edit process module 303 updates the handwritten document which is being displayed, in order to reflect the result of the edit process on the handwritten document.

The user can delete an arbitrary stroke of the plural strokes which are being displayed, by using an “eraser” tool, etc. In addition, the user can designate a range of an arbitrary part in the handwritten page which is being displayed, by using a “range designation” tool for surrounding an arbitrary part on the screen by a circle or a rectangle.

The query stroke acquisition module 307 functions as an acquisition processor configured to acquire a stroke group (query stroke group) which is used as a search key (query). As the query stroke group, use can be made of at least one stroke which is handwritten as a search key (query) by the user on a handwriting search screen which is displayed by the digital notebook application program 202. In addition, at least one stroke in a handwritten page, which is selected by the user, can also be used as the query stroke group.

In order to execute the above-described handwriting search, the search process module 308 includes a stroke search module 309 and an outer shape similarity calculator 310. The stroke search module 309 functions a search processor configured to execute the above-described handwriting search by using the query stroke group which is acquired by the query stroke acquisition module 307. Specifically, the stroke search module 309 executes a handwriting search for searching for strokes corresponding to the query strokes from a handwritten document. In this case, for example, the stroke search module 309 may search for strokes having a characteristic amount, which is similar to a characteristic amount of the query strokes, from the handwritten document. In this handwriting search, strokes corresponding to query strokes, for example, strokes having a characteristic amount similar to a characteristic amount of query strokes, are searched from the handwritten document by matching between strokes. A query stroke group includes at least one stroke, and also each of stroke groups, which are to be searched, includes at least one stroke. As has been described above, as the characteristic amount of each stroke, use may be made of a shape of a stroke, a direction of writing of a stroke, an inclination of a stroke, etc.

Various methods can be used as the method of calculating a similarity between two strokes. For example, each stroke may be treated as a vector. In this case, each stroke may be re-sampled based on original stroke data, so that all strokes may have the same number of points (the number of samples).

Further, in order to normalize the relative positional relationship between the strokes, the vector of each stroke may be converted to a differential vector. For example, when a certain stroke includes a coordinate data series of (x1, y1), (x2, Y2) and (x3, y3), this coordinate data series may be converted to a coordinate data series of (0, 0), (x2-x1, y2-x1) and (x3-x1, y3-y1). By this conversion, all strokes can be regarded as strokes which are written from the origin. Thus, regardless of the position in the handwritten page, at which each stroke was written, the handwriting search can be executed. In the meantime, in the conversion of the coordinate data series, use may be made of an arbitrary conversion method which can normalize the relative positional relationship between strokes.

Furthermore, in order to normalize the magnitude of each stroke, the vector coordinates of each stroke may be divided by a maximum width or a maximum height of each stroke.

Then, in order to calculate the similarity between vectors (differential vectors) which are targets of comparison, an inner product between these vectors (differential vectors) which are targets of comparison may be calculated as the similarity between the vectors (differential vectors) which are targets of comparison.

In addition, in order to reduce the load of calculation, it is possible to calculate in advance the characteristic amount data (characteristic vector) which is representative of the characteristic amount of each stroke in each handwritten document, and to store the characteristic amount data in a database. In this case, the stroke search module 309 can calculate the characteristic amount of a query stroke group, and can search for a stroke group having a characteristic amount similar to the characteristic amount of the query stroke group by using the characteristic amount of the query stroke group and the characteristic amount data of each stroke in the database. Besides, in order to reduce the amount of calculation, a process for reducing the dimensions of the characteristic amount vectors may be executed.

In general, in many cases, the query stroke group is not a single stroke, but a stroke series including a plurality of strokes. In such cases, with respect to each stroke included in the query stroke group (query stroke series), the similarity between this stroke and each of a plurality of strokes in the handwritten document is calculated. Then, taking into account the order of writing of the query stroke series, a query stroke series similar to this query stroke series is searched from the handwritten document. DP (Dynamic Programming) matching may be used in calculating the similarity between two stroke series.

In the meantime, in the handwriting search, with respect to each stroke included in the query stroke series, a stroke corresponding to this stroke is searched. Thus, for example, with respect to each stroke included in the query stroke series, the similarity between this stroke and each of the strokes in the handwritten document is calculated. Depending on a combination between strokes included in the query stroke series, it is possible that, for example, a handwritten character string, which is entirely different from a handwritten character string that was handwritten as a query, is erroneously searched as a stroke series similar to the query stroke series.

For example the case is now assumed that a handwritten character “H” including three strokes was handwritten as a query stroke group. In this case, it is possible that a handwritten character string “1-1” comprising three different characters, for instance, is erroneously searched.

Such an error in the search (erroneous detection of strokes) tends to occur when the query stroke group includes a plurality of strokes.

Taking the above into account, in the embodiment, the outer shape similarity calculator 310 is added to the search process module 308. The outer shape similarity calculator 310 functions a determiner configured to determine whether strokes searched by a handwriting search should be regarded as a search result corresponding to a query, in accordance with the outer shape of query strokes and the outer shape of the strokes searched by the handwriting search. In this case, the outer shape similarity calculator 310 may calculate the similarity between the outer shape of query strokes and the outer shape of strokes searched by the handwriting search. Then, in accordance with the similarity between the outer shapes, the outer shape similarity calculator 310 may determine whether the strokes searched by the handwriting search should be regarded as the search result corresponding to the query.

In some cases, an erroneously detected stroke group is a stroke group having a length which is greatly different from the length of a query stroke group. Thus, it is possible to easily estimate whether a stroke group searched by the handwriting search is an erroneously detected stroke group or not, by the above-described simple process of determining whether strokes searched by the handwriting search should be regarded as a search result corresponding to the query, in accordance with the outer shape of query strokes and the outer shape of the strokes searched by the handwriting search.

As the outer shape of the query stroke group (or the outer shape of the stroke group to be searched), use may be made of an arbitrary shape which can represent a general outer shape (a shape of an outer appearance) of the stroke group.

The outer shape of a two-dimensional area including a certain stroke group, for example, the outer shape of a display area of this stroke group in the screen, may be used as the outer shape of this stroke group. In addition, a circumscribed frame (e.g. a circumscribed rectangle) surrounding the stroke group may be used as the outer shape of the stroke group.

As described above, in many cases, an erroneously detected stroke group has a length (horizontal length) which is different from that of a query stroke group. Thus, as the similarity between outer shapes, use may be made of a similarity between the relative relationship between the width (horizontal length) and height (vertical length) of the outer shape of the query stroke group and the relative relationship between the width (horizontal length) and height (vertical length) of the outer shape of the stroke group that is searched. Specifically, the outer shape similarity calculator 310 determines whether a stroke group, which is searched, should be regarded as a search result corresponding to the query, in accordance with a value relating to the relative relationship between the width and height of the outer shape of the query stroke group and a value relating to the relative relationship between the width and height of the outer shape of the stroke group that is searched. Thereby, without being affected by a difference in size (area) between two stroke groups whose outer shapes are compared, it is possible to precisely estimate whether a stroke group that is searched is an erroneously detected stroke group or not.

Alternatively, the similarity between outer shapes may be calculated, based on the number of handwriting blocks included in a query stroke group and the number of handwriting blocks included in a stroke group that is searched. In this case, the outer shape similarity calculator 310 determines whether a stroke group, which is searched, should be regarded as a search result corresponding to the query, in accordance with a value relating to the number of handwriting blocks included in the query stroke group and a value relating to the number of handwriting blocks included in the stroke group that is searched.

The above-described handwriting block (or simply referred to as “block”) means a set of strokes. In other words, either an isolated stroke or a plurality of strokes, which are close to each other, can be treated as one handwriting block. Strokes, which are connected, may be treated as a plurality of strokes which are close to each other, or strokes, a distance between which is a preset threshold or less, may be treated as a plurality of strokes which are close to each other.

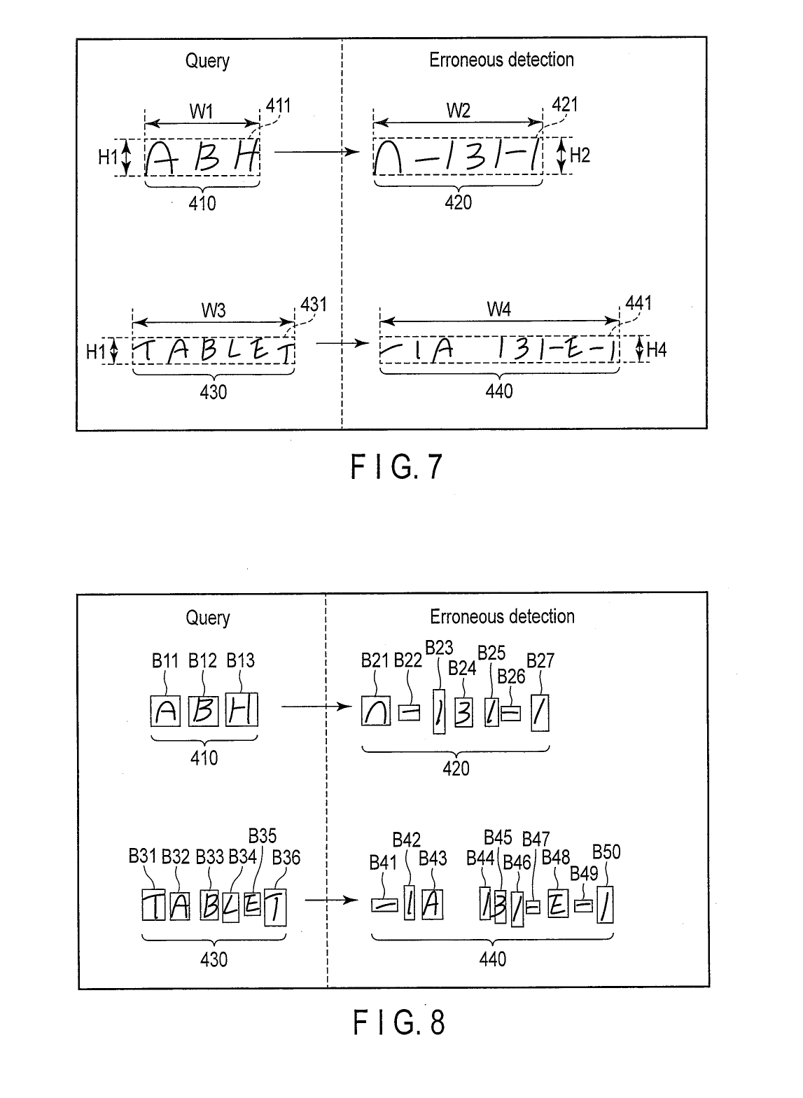

FIG. 7 is a view for explaining strokes which are erroneously detected in a handwriting search, and a process for excluding these strokes from a search result.

The case is now assumed that a stroke group 410 corresponding to a handwritten character string “ABH” was obtained as a query stroke group. In this case, if a handwritten character string, which is shown as a stroke group 420, is present in a handwritten document, it is possible that the stroke group 420 is searched as a stroke group similar to the stroke group 410.

In this embodiment, the outer shape similarity calculator 310 calculates a similarity between the outer shape of the query stroke group 410 and the outer shape of the searched stroke group 420. As described above, various shapes may be used as the outer shape. In the description below, for the simplification of the process, the case is assumed that a circumscribed rectangle is used as the outer shape. The outer shape similarity calculator 310 determines whether the stroke group 420 should be regarded as a search result corresponding to the query, in accordance with a value relating to the relative relationship between the width and height of a circumscribed rectangle 411 of the query stroke group 410 and a value relating to the relative relationship between the width and height of a circumscribed rectangle 421 of the searched stroke group 420. Specifically, the outer shape similarity calculator 310 calculates an aspect ratio of the circumscribed rectangle 411 of the query stroke group 410, and an aspect ratio of the circumscribed rectangle 421 of the searched stroke group 420.

The circumscribed rectangle 411 is a frame representing the outer shape of the query stroke group 410. It can be said that this circumscribed rectangle 411 corresponds to a display area on the screen, on which the handwritten character string “ABH” is displayed. The aspect ratio of the circumscribed rectangle 411 is used as an index indicative of a relative relationship between a width W1 and a height H1 of the circumscribed rectangle 411. Similarly, the circumscribed rectangle 421 is a frame representing the outer shape of the stroke group 420. It can be said that this circumscribed rectangle 421 corresponds to a display area on the screen, on which the stroke group 420 is displayed. The aspect ratio of the circumscribed rectangle 421 is used as an index indicative of a relative relationship between a width W2 and a height H2 of the circumscribed rectangle 421. Either the width/height or the height/width may be used as the aspect ratio of each circumscribed rectangle.

The outer shape similarity calculator 310 compares the aspect ratio (=W1/H1 or H1/W1) of the circumscribed rectangle 411 and the aspect ratio (=W2/H2 or H2/W2) of the circumscribed rectangle 421. When a ratio between these aspect ratios is within a certain threshold range, the outer shape similarity calculator 310 may determine that the outer shape of the query stroke group 410 and the outer shape of the stroke group 420 are similar. When this ratio is out of the threshold range, the outer shape similarity calculator 310 may determine that the outer shape of the query stroke group 410 and the outer shape of the stroke group 420 are not similar. For example, when the aspect ratio of the circumscribed rectangle 411 (the aspect ratio of the outer shape of the query stroke group 410) is A1 and the aspect ratio of the circumscribed rectangle 421 (the aspect ratio of the outer shape of the stroke group 420 that is a search result candidate) is A2, if the value of A2/A1 is in a range of 0.8 to 1.2, the outer shape similarity calculator 310 determines that the outer shape of the query stroke group 410 and the outer shape of the stroke group 420 are similar.

The height H2 of the stroke group 420 is substantially equal to the height H1 of the query stroke group 410, but the width W2 of the stroke group 420 is greater than the width W1 of the query stroke group 410. Accordingly, by comparing the aspect ratio of the query stroke group 410 and the aspect ratio of the stroke group 420, the outer shape similarity calculator 310 can determine that the outer shape of the query stroke group 410 and the outer shape of the stroke group 420 are not similar, and can exclude the stroke group 420 from the search result.

Next, the case is assumed that a stroke group 430 corresponding to a handwritten character string “TABLET” was obtained as a query stroke group. In this case, if a stroke group 440, which can be read as “-1A131-E-1”, for example, is present in a handwritten document, it is possible that the stroke group 440 is searched as a stroke group similar to the stroke group 430. The outer shape similarity calculator 310 compares the aspect ratio (=W3/H3 or H3/W3) of a circumscribed rectangle 431 of the query stroke group 430 and the aspect ratio (=W4/H4 or H4/W4) of a circumscribed rectangle 441 of the stroke group 440, and determines whether the outer shape of the query stroke group 430 and the outer shape of the stroke group 440 are similar or not.

The height H4 of the stroke group 440 is substantially equal to the height H3 of the query stroke group 430, but the width W4 of the stroke group 440 is greater than the width W3 of the query stroke group 430. Accordingly, by comparing the aspect ratio of the query stroke group 430 and the aspect ratio of the stroke group 440, the outer shape similarity calculator 310 can determine that the outer shape of the query stroke group 430 and the outer shape of the stroke group 440 are not similar, and can exclude the stroke group 440 from the search result.

FIG. 8 illustrates a process for calculating a similarity between outer shapes by using the number of handwriting blocks in place of the aspect ratio.

As regards the query stroke group 410, the outer shape similarity calculator 310 classifies the plural strokes in the query stroke group 410, so that an isolated stroke, or a plurality of strokes which are close to each other, may be classified into a single handwriting block. Thereby, the plural strokes in the query stroke group 410 may be classified into three handwriting blocks B11, B12 and B13. Similarly, the outer shape similarity calculator 310 classifies the plural strokes in the stroke group 420, so that an isolated stroke, or a plurality of strokes which are close to each other, may be classified into a single handwriting block. Thereby, the plural strokes in the stroke group 420 may be classified into seven handwriting blocks B21, B22, B23, B24, B25, B26 and B27.

The outer shape similarity calculator 310 compares the number of handwriting blocks in the query stroke group 410 and the number of handwriting blocks in the stroke group 420. When a ratio between these two numbers of blocks is within a predetermined range, the outer shape similarity calculator 310 may determine that the outer shape of the query stroke group 410 and the outer shape of the stroke group 420 are similar. When the ratio between the two numbers of blocks is out of this range, the outer shape similarity calculator 310 may determine that the outer shape of the query stroke group 410 and the outer shape of the stroke group 420 are not similar.

For example, when the number of blocks of the query stroke group 410 is C1 and the number of blocks of the stroke group 420 is C2, if the value of C2/C1 is in a range of 0.8 to 1.2, the outer shape similarity calculator 310 determines that the outer shape of the query stroke group 410 and the outer shape of the stroke group 420 are similar.

The number of blocks of the query stroke group 410 is 3, whereas the number of blocks of the stroke group 420 is 7. Accordingly, the outer shape similarity calculator 310 can determine that the outer shape of the query stroke group 410 and the outer shape of the stroke group 420 are not similar, and can exclude the stroke group 420 from the search result.

Next, the case is assumed that the stroke group 440 corresponding to the handwritten character string “-1A131-E-1” was searched as a stroke group similar to the query stroke group 430 corresponding to the handwritten character string “TABLET”.

As regards the query stroke group 430, the outer shape similarity calculator 310 classifies the plural strokes in the query stroke group 430, so that an isolated stroke, or a plurality of strokes which are close to each other, may be classified into a single handwriting block. Thereby, the plural strokes in the query stroke group 430 may be classified into six handwriting blocks B31, B32, B33, B34, B35 and B36. Similarly, the outer shape similarity calculator 310 classifies the plural strokes in the stroke group 440, so that an isolated stroke, or a plurality of strokes which are close to each other, may be classified into a single handwriting block. Thereby, the plural strokes in the stroke group 440 may be classified into ten handwriting blocks B41, B42, B43, B44, B45, B46, B47, B48, B49 and B50.

The number of blocks of the query stroke group 430 is 6, whereas the number of blocks of the stroke group 440 is 10. Accordingly, the outer shape similarity calculator 310 can determine that the outer shape of the query stroke group 430 and the outer shape of the stroke group 440 are not similar, and can exclude the stroke group 440 from the search result.

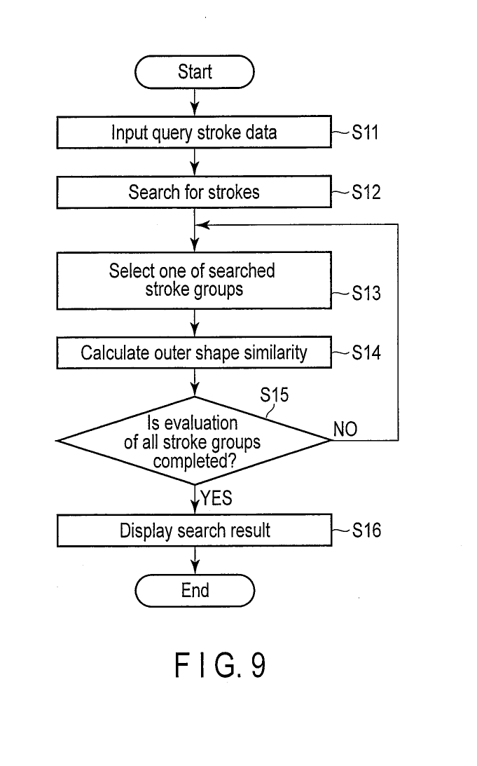

A flowchart of FIG. 9 illustrates the procedure of the entirety of a handwriting search process including the above-described process of calculating the outer shape similarity.

The query stroke acquisition module 307 acquires a query stroke group (query stroke data) which is handwritten on a search screen by a user, and inputs the query stroke data to the search process module 308 (step S11). The query stroke group includes at least one stroke. Thus, the query stroke data is at least one stroke data corresponding to at least one query stroke.

The stroke search module 309 of the search process module 308 searches for a stroke corresponding to each of strokes included in the query stroke group, from a handwritten document that is a search target, by matching between each stroke included in the query stroke group and each of a plurality of strokes in the handwritten document (step S12). In step S12, the stroke search module 309 can search for at least one stroke group corresponding to the query stroke group. In step S12, for example, at least one stroke group having a characteristic amount, which is similar to a characteristic amount of the query stroke group, is searched. In the description below, the case is assumed that a plurality of stroke groups each including at least one stroke were searched as search result candidates corresponding to the query stroke group.

The outer shape similarity calculator 310 selects one stroke group of the plural searched stroke groups (step S13). Then, the outer shape similarity calculator 310 determines whether the selected stroke group should be regarded as a search result corresponding to the query, in accordance with the outer shape of the query stroke group and the outer shape of the selected stroke group. For example, the outer shape similarity calculator 310 calculates a similarity (outer shape similarity) between the outer shape of the query stroke group and the outer shape of the selected stroke group (step S14). In step S14, the outer shape similarity calculator 310 evaluates the likelihood that the selected stroke group corresponds to the query stroke group, and determines whether the selected stroke group should be regarded as the search result corresponding to the query. As described above, if the outer shape similarity between the two stroke groups is within a predetermined range, that is, if the outer shapes of the two stroke groups are similar, the outer shape similarity calculator 310 determines that the selected stroke group should be regarded as the search result corresponding to the query. On the other hand, if the outer shape similarity between the two stroke groups is out of the predetermined range, that is, if the outer shapes of the two stroke groups are not similar, the outer shape similarity calculator 310 determines that the selected stroke group should not be regarded as the search result corresponding to the query.

The outer shape similarity calculator 310 repeatedly executes the process of steps S13 and S14, until the evaluation of all the searched stroke groups is completed (step S15). If the evaluation of all the searched stroke groups is completed (YES in step S15), the search process module 308 excludes from the search result the stroke groups which have been determined to have a low outer shape similarity, based on the evaluation result by the outer shape similarity calculator 310. The search process module 308 displays on the search result screen only the stroke group which has been determined to be the search result (step S16). Thereby, since handwritten character strings, for example, which are entirely different from a handwritten character string corresponding to a query stroke group, can be prevented from being output as a search result, the precision of the handwriting search process can be enhanced.

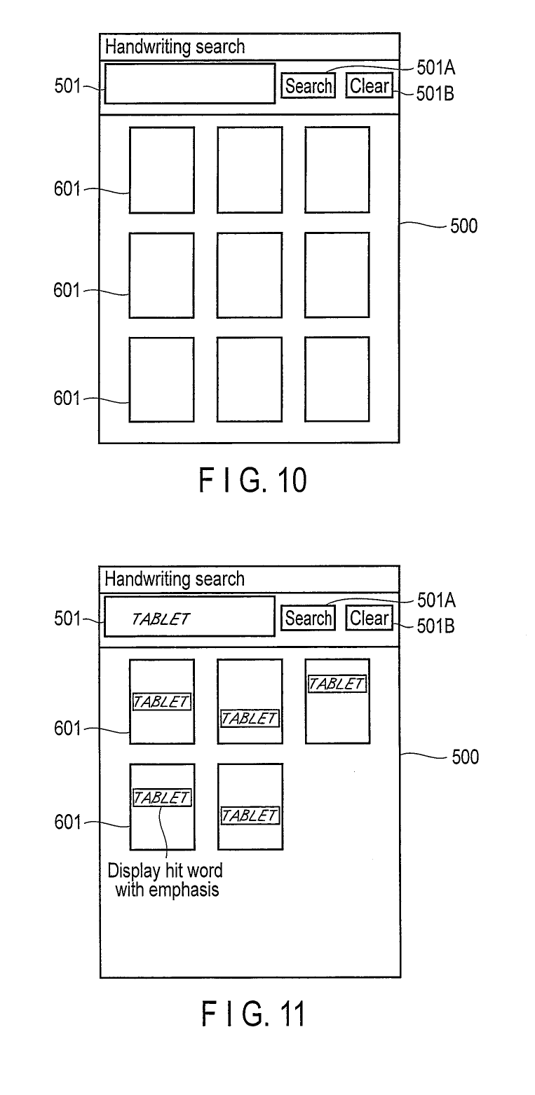

FIG. 10 illustrates a handwriting search screen 500 which is presented to the user by the digital notebook application program 202.

The handwriting search screen 500 displays a search key (query) input area 501, a search button 501A and a clear button 501B. The search key input area 501 is an input area for handwriting a character string or a graphic, which is to be set as a search key (query). The search button 501A is a button for instructing execution of a handwriting search process. The clear button 501B is a button for instructing deletion (clear) of a character string or graphic, which is handwritten in the search key input area 501.

The handwriting search screen 500 may further display a plurality of handwritten page thumbnails 601. In the example of FIG. 10, nine handwritten page thumbnails 601 corresponding to nine handwritten documents are displayed.

As shown in FIG. 11, when a gesture (e.g. a tap gesture), which is performed on the search button 501A, has been detected in the state in which a handwritten character string “TABLET”, for example, is input in the search key input area 501, the digital notebook application program 202 starts a handwriting search for searching for stroke groups, each of which has a characteristic amount similar to the characteristic amount of a query stroke group corresponding to the handwritten character string “TABLET”, from each of the nine handwritten documents. Then, the digital notebook application program 202 determines whether each of the searched stroke groups should be regarded as a search result corresponding to the search key, based on a similarity (outer shape similarity) between the outer shape of each of the stroke groups searched by the handwriting search and the outer shape of the query stroke group.

In this case, the digital notebook application program 202 excludes, from the search result, stroke groups whose outer shapes (e.g. the aspect ratio, or the number of handwriting blocks) are sharply different from the outer shape (e.g. the aspect ratio, or the number of handwriting blocks) of the query stroke group. Then, handwritten page thumbnails corresponding to some handwritten documents including the query stroke groups (in this example, the handwritten character string “TABLET”), which have been determined to have a relatively high outer shape similarity, are displayed as a search result on the handwriting search screen 500. FIG. 11 illustrates the case in which five handwritten pages of the nine handwritten pages are displayed as the search result. Hit words, that is, the handwritten character strings “TABLET” in the five handwritten page thumbnails, are displayed with emphasis.

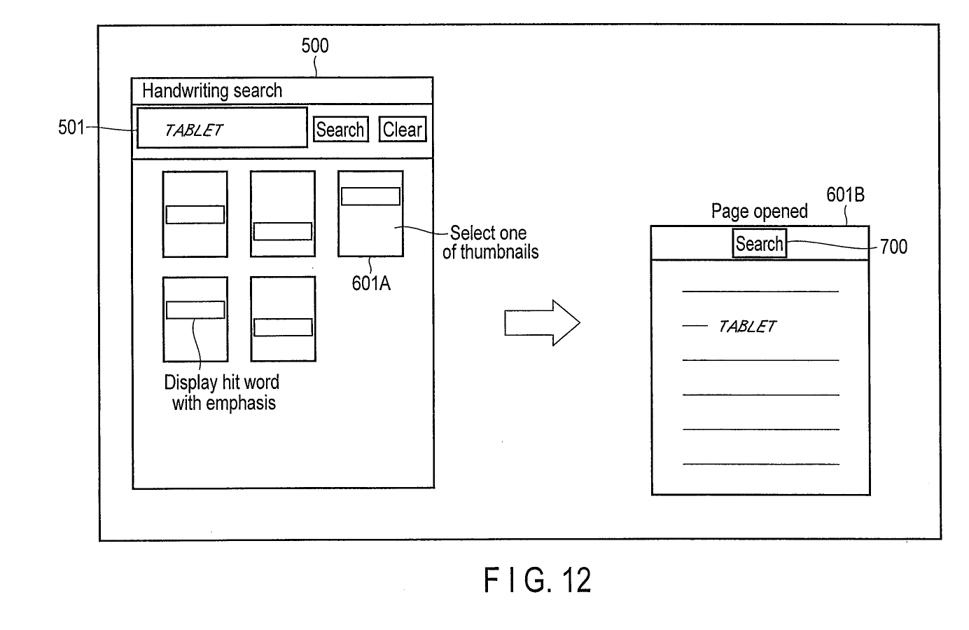

When one of the five searched handwritten page thumbnails has been selected by the user, as shown in FIG. 12, a handwritten page 601B corresponding to a selected handwritten page thumbnail 601A is displayed on the screen with the normal size. A search button 700 is displayed on the handwritten page 601B. If the search button 700 has been tapped by the user, the content of the display screen is restored to the search screen, which is shown in the left part of FIG. 12.

As has been described above, in the embodiment, a handwriting search is executed for searching for second strokes corresponding to first strokes, which are a search key, from a handwritten document. Then, in accordance with the outer shape of the first strokes and the outer shape of the second strokes which are searched by the handwriting search, it is determined whether the second strokes should be regarded as a search result corresponding to the search key. Thus, handwritten character strings, for example, which are entirely different from a handwritten character string corresponding to the first strokes, can be prevented from being presented to the user as a search result, and the precision of the handwriting search process can be enhanced.

Since the various processes on handwritten documents in the embodiment can be realized by a computer program, the same advantageous effects as with the present embodiment can easily be obtained simply by installing the computer program into a computer through a computer-readable storage medium which stores the computer program, and executing the computer program.

As described above, the functions of the handwriting search process of the embodiment may be realized by a local system in the tablet computer 10. However, these functions may also be realized by a server system which is composed of one or more servers. Alternatively, use may be made of a system configuration in which a part of the functions of the handwriting search process is executed by the tablet computer 10, and the other part are executed by using one or more servers.

In the embodiment, the case in which the tablet computer is used has been described by way of example. However, the handwritten document processing function of the embodiment is applicable to an ordinary desktop personal computer. In this case, it should suffice if a tablet or the like, which is an input device for a handwriting input, is connected to the desktop personal computer.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system comprising:
an input configured to input first strokes which indicate a search key;
a processor configured to execute a handwriting search to search for second strokes corresponding to the first strokes from a handwritten document, and to determine whether the second strokes searched by the handwriting search should be regarded as a search result corresponding to the search key, based on an outer shape of the first strokes and an outer shape of the second strokes.

2. The system of claim 1, wherein the processor is configured to determine whether the second strokes should be regarded as the search result corresponding to the search key, based on a value relating to a relative relationship between a width and a height of the outer shape of the first strokes and a value relating to a relative relationship between a width and a height of the outer shape of the second strokes.

3. The system of claim 1, wherein the processor is configured to determine whether the second strokes should be regarded as the search result corresponding to the search key, based on a value relating to a relative relationship between a width and a height of a rectangle circumscribing the first strokes and a value relating to a relative relationship between a width and a height of a rectangle circumscribing the second strokes.

4. The system of claim 3,
wherein the value relating to the relative relationship between the width and the height of the rectangle circumscribing the first strokes is an aspect ratio of the rectangle circumscribing the first strokes, and
the value relating to the relative relationship between the width and the height of the rectangle circumscribing the second strokes is an aspect ratio of the rectangle circumscribing the second strokes.

5. The system of claim 1, wherein the processor is configured to determine whether the second strokes should be regarded as the search result corresponding to the search key, based on a value relating to a number of handwriting blocks included in the first strokes and a value relating to a number of handwriting blocks included in the second strokes.

6. The system of claim 5,
wherein the handwriting blocks in the first strokes are obtained by classifying strokes in the first strokes such that either an isolated stroke or a plurality of strokes that are close to each other are classified into one handwriting block, and
the handwriting blocks in the second strokes are obtained by classifying strokes in the second strokes such that either an isolated stroke or a plurality of strokes that are close to each other are classified into one handwriting block.

7. The system of claim 1, wherein the processor is configured to determine that the second strokes are to be excluded from the search result corresponding to the search key, if a similarity between the outer shape of the first strokes and the outer shape of the second strokes is less than a first similarity.

8. The system of claim 1, wherein the processor is configured to search the handwritten document for a stroke corresponding to each stroke included in the first strokes, by comparing each of the strokes included in the first strokes with each of a plurality of strokes in the handwritten document.

9. A method comprising:
inputting first strokes which indicate a search key;
executing a handwriting search to search for second strokes corresponding to the first strokes from a handwritten document; and
determining whether the second strokes searched by the handwriting search should be regarded as a search result corresponding to the search key, based on an outer shape of the first strokes and an outer shape of the second strokes.

10. The method of claim 9, wherein the determining includes determining whether the second strokes should be regarded as the search result corresponding to the search key, based on a value relating to a relative relationship between a width and a height of the outer shape of the first strokes and a value relating to a relative relationship between a width and a height of the outer shape of the second strokes.

11. The method of claim 9, wherein the determining includes determining whether the second strokes should be regarded as the search result corresponding to the search key, based on a value relating to a number of handwriting blocks included in the first strokes and a value relating to a number of handwriting blocks included in the second strokes.

12. A computer-readable, non-transitory storage medium having stored thereon a computer program which is executable by a computer, the computer program controlling the computer to execute functions of:
inputting first strokes which indicate a search key;
executing a handwriting search to search for second strokes corresponding to the first strokes from a handwritten document; and
determining whether the second strokes searched by the handwriting search should be regarded as a search result corresponding to the search key, based on an outer shape of the first strokes and an outer shape of the second strokes.

13. The storage medium of claim 12, wherein the determining includes determining whether the second strokes should be regarded as the search result corresponding to the search key, based on a value relating to a relative relationship between a width and a height of the outer shape of the first strokes and a value relating to a relative relationship between a width and a height of the outer shape of the second strokes.

14. The storage medium of claim 12, wherein the determining includes determining whether the second strokes should be regarded as the search result corresponding to the search key, based on a value relating to a number of handwriting blocks included in the first strokes and a value relating to a number of handwriting blocks included in the second strokes.
